(19) United States
(12) Patent Application Publication
(10) Pub. No.: US 2004/0187693 A1
(43) Pub. Date: Sep. 30, 2004

(54) Method for controlling a drink preparation machine

(76) Inventor: Leonard Fuchs, Treffelhausen (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/758,186

(22) Filed: Jan. 15, 2004

(30) Foreign Application Priority Data
Mar. 24, 2003 (EP) 03006724.3

(51) Int. Cl. A23L 1/00

(52) U.S. Cl. 99/275

(57) ABSTRACT

A method for controlling a drink preparation machine (1) for preparing a multiple number of different drink units on a hot water basis, including withdrawing the multiple number of drink units from the same hot water source (8), and, so as to design the withdrawal in a way that provides a higher capacity, monitoring the performance status of the hot water source (8), and controlling the hot water withdrawal in such a way that the hot water withdrawal is released for all drink units at a predetermined full performance status (I), blocked for all drink units at a predetermined zero performance status and, at a predetermined partial performance status (II), blocked for predetermined drink units and released for other predetermined drink units.

The invention relates to a method for controlling a drink preparation machine.

In the case of a drink preparation machine that works with hot water, such as, in particular, a coffee machine, with its possibilities of always freshly preparing the widest variety of drinks, automatically or largely automatically, each time upon the request of the user, it must be ensured that the hot water withdrawn from this machine's hot-water apparatus always presents the necessary temperature, regardless of how much or how often hot water is withdrawn. Depending on the type of hot-water apparatus, one therefore has generally blocked the withdrawal of hot water as soon as it has been established that, for example, the water level in a steam boiler has sunk below the lower level electrode, regardless of the fact that the hot water remaining in the steam boiler, while perhaps not sufficient for a large amount of hot drinks, would definitely allow the withdrawal of a small amount. This course of action is uneconomical and results in annoying waiting times for the user.

The object of the invention is to provide a method with which the amount of hot water that is available can be used more economically.

This object is solved by means of the features in claim 1.

Using the development according to the invention, a dynamic withdrawal control system is realized, with which it is ensured that the completely heated hot water that is available can be used “to the last drop” for brewing; consequently, the necessity of blocking the hot water delivery prematurely arises considerably less often.

Advantageous further developments of the invention can be derived from the sub-claims.

Embodiments of the invention are explained in more detail in the following, using the drawings. Shown are:

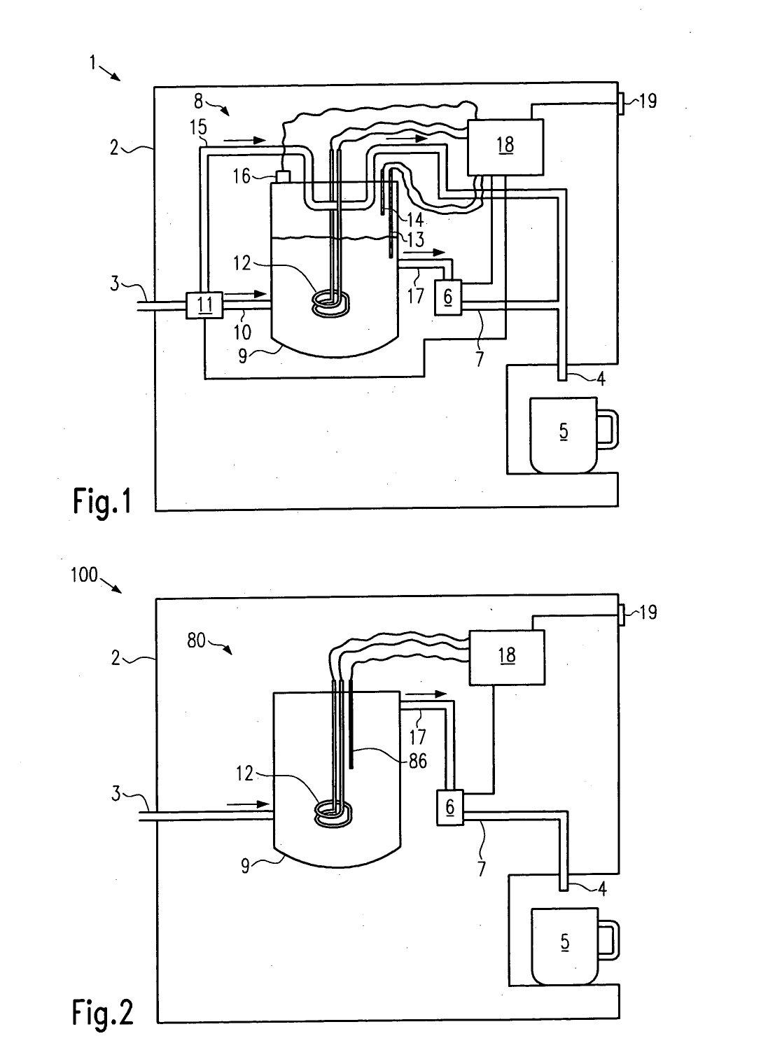

FIG. 1 a first embodiment of a drink preparation machine, in schematic representation, for carrying out the method according to the invention;

FIG. 2 a second embodiment of a drink preparation machine, in schematic representation, for carrying out the method according to the invention; and

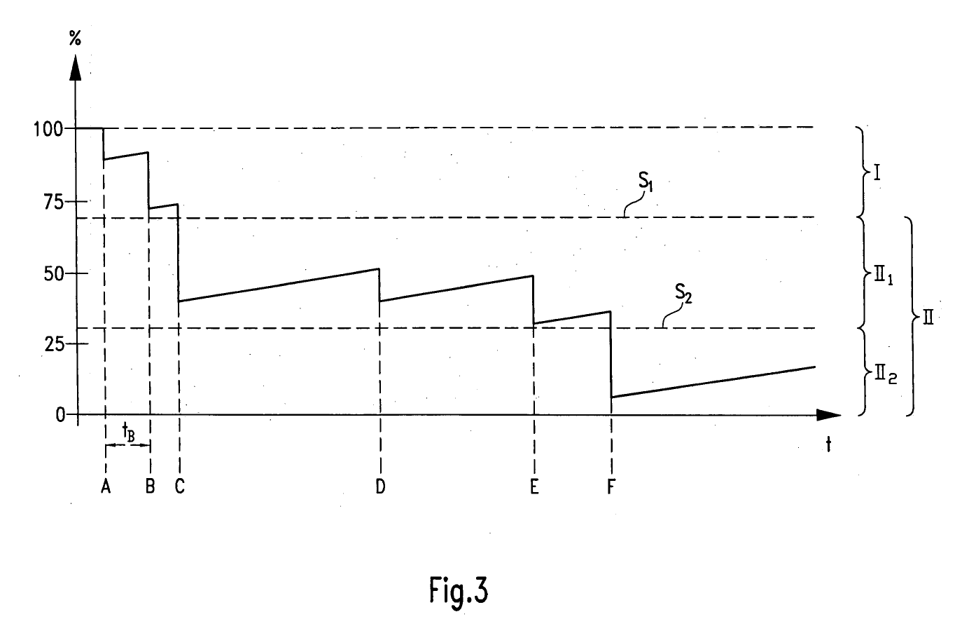

FIG. 3 a schematic representation of a performance-time graph when the method according to the invention is carried out.

FIG. 1 shows a first embodiment of a drink preparation machine 1, which, in the case under consideration, is formed as a coffee machine, which, as is customary for modern coffee machines that work automatically or largely automatically, can prepare and dispense a large number of drinks, such as normal coffee, expresso, tea, a shot of steam for forming foam, etc., in amounts of different sizes (pot, cut, small cup, glass, etc.). The coffee machine 1 includes a housing 2, into which a water connection 3 runs and out of which a drink outlet 4 runs. In the depicted embodiment, only one drink outlet 4 is shown, but several outlets, each for a different drink, could be provided. The customary drink or serving containers are placed under the outlet; a cut 5 is shown.

The customary elements of a coffee machine are arranged in and on the housing 2, whereby, for reasons of clarity, only one brewing device 6 is depicted schematically; this brewing device 6 is connected to the outlet 4 by means of a line 7.

Furthermore, provided in the housing 2 is a hot-water apparatus 8, which is formed as a steam boiler of customary design in the embodiment depicted. The steam boiler 8 holds the customary boiler 9, which is connected to the cold water inlet 3 by means of a line 10 and a supply valve 11. A heater 12 is provided inside the boiler. The liquid level in the boiler is monitored using a low water electrode 13 and an operating water electrode 14, whereby the level can fluctuate between the two electrodes 13 and 14. Furthermore, a customary continuous-flow heater 15, in the form of a pipe coil that runs through the boiler, is provided in the boiler to prepare the steam. Finally, a pressure sensor 16 is provided on the boiler to monitor the operating pressure inside the boiler 9.

A hot water line 17 connects the steam boiler 8 to the brewing device 6.

The supply valve 11, heater 12, level electrodes 13 and 14, as well as the pressure sensor 16 and brewing device 6, are connected to a control device 18. Also connected to the control device 18 are operating elements 19, on the exterior of the housing, with which the user can pre-select the desired drink in the desired amount, whereby a preparation cycle is started for this drink.

With steam boilers, it is normally only possible to feed in as much cold water as can simultaneously be heated up to the target temperature (usually 120° C.). The steam pressure and consequently the temperature must remain constant. The boiler capacity or working capacity of the steam boiler 8 is coordinated to these requirements, depending on other parameters, such as the size of the boiler 9 and the inlet temperature of the water, by positioning the upper and lower level electrodes 13 and 14. If the steam boiler 8 has reached its maximum level and target pressure, it has a capacity or readiness level of 100%.

The amounts of thermal energy, in the form of hot water, to be withdrawn in order to prepare the individual drink units are also known and are used to calculate a code number for each drink unit and are saved in the control device 18. Each drink dispensed in a preparation and dispensing cycle is defined as a “drink unit” —consequently, for example, a small cup of expresso, a glass of tea, a pot of coffee, a shot of steam, etc. Furthermore, the type and number of drink units pre-selected via the operating elements 19 are stored in the control device 18 and used for operation of the drink preparation machine 1 according to the invention, as shown in FIG. 3.

In FIG. 3, applied to the steam boiler 8 of FIG. 1, 100% capacity or power capability means a steam boiler 8, filled up to the upper level electrode 14 and brought up to the target temperature and target pressure. Zero % capacity of power capability means a water level in the boiler 9 that has sunk to the level of the lower level electrode 13 or a target pressure or target temperature outside of the normal tolerance range. The capacity is monitored by means of the level and the pressure, or, if desired, the temperature.

To carry out the method according to the invention, the performance range between zero and 100% is divided into separate ranges using threshold values. A full performance range I, in which dispensing functions are allowed without restriction, is defined between a capacity of 1—% and a capacity of roughly 70% (first threshold value S₁). A second performance range, partial performance range II, is defined below the threshold value S₁ and down to the capacity zero %; in the embodiment shown, this partial performance range II is sub-divided by a second threshold value S₂ into partial performance ranges II₁ and II₂, whereby the first partial performance range II₁ is defined at between roughly 70% and roughly 30% capacity and the second partial performance range II₂ is defined as between roughly 30% and zero % capacity. Below zero % capacity, a zero performance range extends, in which no dispensing is possible.

If a user selects a particular drink unit, the amount of heat to be withdrawn for it is stored and compared with the performance status, i.e., the available capacity of the steam boiler 8 at this time. Within the full performance range I, there are no restrictions, i.e., any number of drink units can be drawn. In FIG. 3, a first drawing step A is carried out and, after the expiry of a length of time t₈, a second drawing step B is carried out. After the first drawing step A, the heater 12 is switched on, which leads to an increase in the capacity, characterised by the rise in the curve between A and B. Because of withdrawal step B, a larger amount of hot water is withdrawn, which leads to a larger fall in the capacity or readiness level compared to withdrawal step A. The control device adds with withdrawn capacity or heat amount for each withdrawal step (in the form of the code numbers) and creates a performance status, i.e., it establishes the distance between the capacity and the threshold value S₁. Shortly after withdrawal step B, a third withdrawal step C is initiated, which results in the withdrawal of a large amount of hot water. The capacity falls into partial performance range II, i.e., into the upper part of partial performance range II₁. In this range, parallel withdrawal is restricted to a predetermined amount of heat, so that, for example, only two products with slight hot water requirements and/or only one product with a higher hot water requirement can still be withdrawn, whereby heating will take place again after each withdrawal. If withdrawal steps D and E are also initiated and executed, and if the time between the withdrawal steps is not long enough to allow the steam boiler to return to the full performance range II, if there is a further withdrawal step F, the steam boiler lands in the lower partial performance range II₂, in which, for example, it is possible to dispense only one drink unit. Only at this time is dispensing blocked for all drink units; it remains blocked until the steam boiler 8 has reached its full performance capacity again.

The method according to the invention is applicable in the same way to other drink preparation machines with other hot water generators. Consequently, FIG. 2 shows a drink preparation machine 100, which is again in the form of a coffee machine for automatic or semi-automatic operation, whereby the same or comparable components are identified with the same reference numbers as in FIG. 1, but are not explained again. The drink preparation machine 100 includes a hot-water apparatus in the form of a boiler 80 with a boiler container 9, into which a heater 12 and a thermal sensor 86 are placed. The hot water line 17 here runs out of the upper area of the boiler container 9 and into the brewing device 6. One boiler is always filled and as much cold water is then drawn in as hot water was withdrawn. The temperature stratification in the boiler nevertheless allows water at the target temperature (typically 96° C.) to be withdrawn. The target temperature is controlled via the thermal sensor 86 in the middle area of the boiler. For the Purposes of FIG. 3, the boiler capacity corresponds to 100% when the average temperature of the boiler 80 is steady, i.e., for example at the end of the heating cycle. Zero % capacity corresponds to a boiler temperature at the lower limiting value of the range for the temperature.

Performing the withdrawal step according to the invention according to FIG. 3 is the same for the drink preparation machine 100 as for drink preparation machine 1, except with the sole difference that the capacity is monitored by means of the temperature in this case.

As a modification of the embodiments described and depicted here, the method according to the invention can be modified for each type of hot-water apparatus. It is furthermore possible to provide more than two partial performance ranges or only one partial performance range.

I claim:

1. Method for controlling a drink preparation machine (1) for preparing a multiple number of different drink units on a hot-water basis, comprising the steps of withdrawing the hot water for the multiple number of drink units from the same hot water source (8), monitoring the performance status of the hot water source (8), and controlling the hot water withdrawal in such a way that the hot water withdrawal is released for all drink units at a predetermined full performance status (I), is blocked for all drink units at a predetermined zero performance status and, at a predetermined partial performance status (II), is blocked for certain drink units and released for other predetermined drink units.

2. Method according to claim 1, wherein each performance status is limited by a threshold value (S), and blocking the withdrawal of predetermined drink units if this threshold value is fallen below.

3. Method according to claim 1, wherein the full performance status (I) is formed as a performance range.

4. Method according to claim 3, wherein the partial performance status (II) comprises at least one performance range (II₁, II₂).

5. Method according to claim 1, and establishing a performance withdrawal value for each drink unit, and deducting this performance withdrawal value from the current performance status with each withdrawal.

6. Method according to claim 1, and heating up the hot water synchronously with the withdrawal.
